(19) United States
(12) Patent Application Publication
(10) Pub. No.: US 2010/0332418 A1
(43) Pub. Date: Dec. 30, 2010

(54) Financial methods using an equity option based charitably integrated business operation

(76) Inventor: Gerald Bernard Treacy, JR., Poulsbo, WA (US)

Correspondence Address: Gerald B. Treacy, Jr., Pro Se, 15809 Virginia Point Road NE, Poulsbo, WA, 98370, US

(21) Appl. No.: 12/803,459

(22) Filed: Jun. 28, 2010

Related U.S. Application Data
(62) Division of application No. 11/551,227, filed on Oct. 19, 2006, now abandoned.
(60) Provisional application No. 60/728,110, filed on Oct. 19, 2005.
(60) Provisional application No. 60/734,671, filed on Nov. 8, 2005.
(60) Provisional application No. 60/778,894, filed on Mar. 3, 2006.
(60) Provisional application No. 60/798,882, filed on May 8, 2006.

(51) Int. Cl. G06Q 90/00

(52) U.S. Cl. 705/500

(57) ABSTRACT

Supporting charitable giving by a business in furtherance of a business objective comprises granting, by the business to the charity, an option to purchase an equity interest in the business at a bargain price. If an exercise condition or an event of the option occurs, the business tenders to the charity the equity interest and receives the bargain price. The business receives an income tax deduction for tendering the equity interest upon the charity's exercise of the option.

### CROSS-REFERENCE TO RELATED APPLICATIONS

This is a division of application Ser. No. 11/551,227, filed Oct. 19, 2006.

The present application claims priority from provisional application Ser. No. 60/728,110 entitled “Tax Trusts,” filed on Oct. 19, 2005, from provisional application Ser. No. 60/734,671 entitled “Business Planning Trusts,” filed on Nov. 8, 2005, from provisional application Ser. No. 60/778,894 entitled “Business Yield Enhancement Trust,” filed on Mar. 3, 2006, and from provisional application Ser. No. 60/798,882 entitled “Charitably Integrated Business Operations,” filed on May 8, 2006, the benefit of the earlier filing dates of which is hereby claimed under 35 U.S.C. §119(e), and each of which are further incorporated by reference.

### FIELD OF INVENTION

This invention generally relates to for-profit businesses, specifically, but not exclusively, to the use of charitable planned giving techniques to increase profitability of the businesses. More specifically, the invention relates to an improved and/or less expensive method and system for one or more of the following: 1) mergers and acquisitions; 2) selling a business asset; 3) compensation of business executives and handling other business liabilities; 4) handling income streams which are temporarily undesirable; 5) attracting and retaining top executives; and 6) pre-planning for the tax consequences of a future high-income year.

### BACKGROUND OF THE INVENTION

Performing charitable works by a business is generally desirable. Moreover, meeting business goals, such as increasing profits, or decreasing taxes, is also generally desirable. Currently, however, these goals have not been readily or easily integrated. It is with respect to these however, these goals have not been readily or easily integrated. It is with respect to these considerations and others that the present invention has been made. In order to understand the background of the invention, current business practices are presented below, followed by legal frameworks, structures and tools available to conduct business transactions under U.S. law.

I. Current Business Practices

Merger and Acquisition (M&A). M&As, as they were traditionally crafted, involved considerable negative tax consequences for the acquired or selling firm, and considerable expense for the acquiring or purchasing firm. The seller or its owners recognized taxable income on the sale of its stock or assets, and the buyer's offer needed adequately to compensate the seller and owners for this expense. Often these tax considerations made otherwise viable mergers and acquisitions impractical, and drove up the purchase price even in successful M&As.

Business Asset Sales. Whenever any for-profit business (whether organized as a C or S corporation, a limited liability company (LLC), a partnership, a real estate investment trust (REIT), a Massachusetts trust, or other form of business entity) sold an asset which has appreciated in value above the business's tax basis in the asset, the business owed tax based on the amount of appreciation realized in the sale. For C corporations, this appreciation would usually be taxed as ordinary income, and for S corporations, LLCs, and partnerships, this appreciation would usually be taxed as capital gain to the business owners if the applicable holding periods were satisfied. This tax consequence is disadvantageous to the business in terms of its profitability.

Executive Compensation. Also, when a for-profit business (e.g., whether organized as a C or S corporation, a limited liability company (LLC), or a partnership, a real estate investment trust (REIT), a Massachusetts trust, or other form of business entity) compensated its executives, the business would not generate any tax savings in the form of a charitable deduction, and would not receive any community goodwill or favorable publicity as a “good business citizen.” Similarly, the business funds used to pay the executive were generally subject to the claims of creditors of the business.

Businesses' Unwanted Income. A for-profit business (e.g., whether organized as a C or S corporation, a limited liability company (LLC), or a partnership, a real estate investment trust (REIT), a Massachusetts trust, or other form of business entity) facing high income tax liability strove to reduce temporarily “unwanted” income through a variety of less effective means, including investment in complex domestic and offshore enterprises which in theory temporarily reduce income. Sometimes these income-reducing schemes were structured on a shaky legal and accounting basis. The tax consequences of the temporarily unwanted income is disadvantageous to the business in terms of its profitability.

Businesses' High-Income Years. Whenever any for-profit business (e.g., whether organized as a C or S corporation, a limited liability company (LLC), or a partnership, a real estate investment trust (REIT), a Massachusetts trust, or other form of business entity) had a year characterized by higher-than-average income, the business or its owners often had a higher-than average income tax liability. This tax consequence is disadvantageous to the business and its owners in terms of the expense involved.

II. Summary of Relevant Aspects of U.S. Corporate and Tax Law.

Stock. As used herein, the terms “stock” and “equity” refer to any type of equity ownership in a business, including preferred stock, common stock, LLC units, partnership units, or the like.

C Corporations. A “C corporation” is a corporation governed by Subchapter C of Chapter 1 of Subtitle A of Title 26 of the United States Code. Subchapter C is entitled, “Corporate Distributions and Adjustments,” and contains Code Sections 301-385 (and hence includes the tax-free reorganization provisions of Code Section 368). Chapter 1 of the Code, in turn, is entitled, “Normal Taxes and Surtaxes.” Subtitle A of Title 26 is entitled, “Income Taxes.” Title 26 of the United States Code, is entitled, “Internal Revenue Code” (“Code”).

A C corporation can be either privately held (also called “closely held”), or publicly traded, with corporate stock as the (usual) unit of equity participation.

A C corporation is generally not entitled to use the (lower) capital gains tax rates, but instead reports transactions which would, in other contexts (individuals, S corps, LLCs, partnerships, etc.), constitute capital gains transactions. For example, on the sale of an appreciated capital asset, the C corporation is generally taxed on the realized appreciation at ordinary income tax rates, rather than the lower capital gains tax rates. These corporate ordinary income tax rates are set forth in Code Section 11(b), and range from 15% to 35%, in a graduated schedule.

Pass-Through Entities. Some business entities other than C corporations, including S corporations, limited liability companies, general partnerships, and limited partnerships, can utilize the lower capital gains tax rates (e.g., 15%) in some circumstances, including the sale of appreciated long-term capital assets. For these entities, the sale of certain other assets, including inventory and stock in trade, will generate ordinary income rather than capital gain, and will be taxed at the (higher) ordinary income tax rates.

S Corporations. An S corporation is a corporation which is described in Subchapter S of Chapter 1 of the Code. Subchapter S is entitled, “Tax Treatment of S Corporations and Their Shareholders.” The tax treatment of an S corporation varies in a number of ways from the tax treatment of a C corporation. Perhaps most significantly, an S corporation is a “pass-through” entity for tax purposes; that is, instead of the S corporation itself paying taxes, obtaining deductions and credits, etc., these taxes, deductions and credits “pass through” to the S corporation's owners (i.e., shareholders, as stock is the (usual) unit of equity ownership in an S corporation as in a C corporation), and is reported on the owners' federal income tax returns. Hence, the sale of an appreciated long-term capital gain asset by an S corporation would typically result in a capital gains tax passed through to the owners, for reporting on their own federal income tax returns. A sale of inventory or stock in trade would, in contrast, generally result in “pass through” tax to the owners at ordinary income tax rates. Similarly, a charitable income tax deduction generated by a charitable contribution made by an S corporation would “pass through” to the owners of the S corporation, for use on their own returns.

LLCs. A limited liability company (or “LLC”) is another type of “pass through” entity. The units of ownership are typically described as “LLC units,” or “membership units,” and can have other names. Some LLCs are publicly traded; most appear to be privately owned.

Partnerships. A partnership is another type of “pass through” entity for tax purposes. A partnership can be organized either as a “general” partnership, in which the partners generally share profits and liabilities, or as a “limited” partnership, in which the limited partners have some protections against liability. Some partnerships are publicly traded; probably most are privately owned.

“Check the Box”. Most LLCs and partnerships can elect to be treated as a corporation for tax purposes, under the so-called “check the box” rules.

Ordinary Income Assets v. Capital Gain Assets. The Code imposes a distinction between “ordinary income assets,” such as inventory and stock in trade, the sale of which generally triggers recognition of ordinary income, and “capital assets,” the sale of which can generate (lower) capital gains tax, if the asset satisfies the applicable “holding period” and qualifies as a “long-term capital asset.”

Merger and Acquisition (M&A). The terms “merger and acquisition” and “M&A” refer to both a merger or an acquisition or a combination of a merger and an acquisition, as well as any other variety of business acquisition or combination, whether involving the acquisition of equity, the acquisition of assets, or the acquisition of a combination of equity and assets. An M&A may take a variety of forms. Generally speaking, a “merger” is a transaction in which two formerly autonomous business entities become a single entity (though the process is probably seldom that clean cut). Similarly, generally speaking, an “acquisition” is the transfer of assets or ownership units, or both, of one business entity, often called, loosely, the “acquired” firm, to another business entity, often called, again loosely, the “acquiring” firm.

It is quite possible that a merger or acquisition may involve more than two firms, or may involve a division or portion of a firm rather than the firm in its entirety, or the like.

Again, generally speaking, mergers and (or) acquisitions can fall into one of two broad categories: asset sales and stock sales. And there certainly may be mergers or acquisitions that involve the sale of both assets and stock.

A stock sale involves the acquisition of the acquired firm's stock or other forms of equity units, and can often involve sales by shareholders or owners, including individual owners.

Many acquiring firms prefer not to acquire stock in the acquired firm, partly out of concern that stock ownership may carry with it liabilities, including unknown or unsuspected liabilities, that attend ownership. Instead, many firms prefer “asset sales,” (which may sometimes be called “asset purchases”—again, terminology in this whole area is generally loose and informal), which in general may help to minimize unknown or unforeseen liabilities (or even known ones). An asset sale may involve the sale of a combination of asset types, including long-term capital assets, short-term capital assets (i.e., those capital assets which have not been held by the company long enough to qualify as long-term capital assets), inventory, stock in trade, etc. They may consist of real property (both improved and unimproved), fixtures, intangibles, goodwill, tangible personal property, etc. Typically, an asset sale would involve the purchase of such assets from the “acquired” firm.

Whether the acquisition involves a stock sale (or other equity unit sale) or an asset sale, or both, some common elements include the following: (1) the acquiring firm (or its surrogates) is paying a purchase price of some sort (which may be cash, may be assets, may be promises or undertakings, may be a promissory note, or may be any combination of these and every other conceivable type of property or interest); (2) the purchase price usually must be sufficiently high to permit the acquired firm (and/or its owners) to cover the tax liability generated by the sale; and (3) the purchase price usually includes what might be called a “profit” element, which is designed to compensate the acquired firm and/or its owners, beyond expenses and tax liabilities.

Some corporate reorganizations involving mergers or acquisitions are exempt from federal income tax, if they fit within the categories of “tax-free reorganizations” set forth in Section 368 of the Internal Revenue Code (“Code”). However, given the relative narrowness of these tax-free reorganizations, as a practical matter, relatively few mergers or acquisitions in fact satisfy the Code Section 368 rules. Hence, most mergers and (or) acquisitions are taxable, in whole or part.

The tax consequences to the acquired firm or its owners will depend on a number of factors, including the nature of the assets or ownership units acquired (whether these are capital assets or ordinary income assets, e.g.), and the nature of the business entity whose stock or assets (or both) is being acquired.

Not all mergers or acquisitions which are desired in fact take place. A large number of things can “go wrong,” including the reluctance of the acquired firm or its owners to be exposed to tax liability attendant on the acquisition, and the reluctance of the acquiring firm to pay enough to make its offer attractive. Similarly, there may at times be a competition or “bidding war” between two or more would-be acquirers, or two or more acquisition potential firms. Often, the difference between a successful and unsuccessful bid often involves the amount of the purchase price and the amount of tax liability involved (in addition to various “sweeteners,” etc.) Mergers and acquisitions negotiations can be highly complicated, often with “everything on the table” for negotiation and resolution. Some acquisitions are welcomed by the would-be acquired firms, others are not.

### BRIEF SUMMARY OF THE INVENTION

In accordance with one aspect of the invention, a method supports charitable giving in furtherance of a business objective of the business. The method includes the step of proceeding with the business objective in response to a decision by a decision maker by performing at least one of several other steps. This method comprises the steps of granting, by the business to a charity, an option to purchase an equity interest in the business at a bargain price; determining if an exercise condition or an event of the option occurs. If the exercise condition or the event of the option occurs, then the business tenders to the charity the equity interest; and the business receives from the charity the bargain price. Moreover, the business receives an income tax deduction for tendering the equity interest upon the charity's exercise of the option

Accordingly, one or more advantages can be had depending on the steps to implement various aspects, including:

A business can engage in a merger & acquisition while minimizing current taxes.

A business can sell appreciated assets without owing current taxes.

A business can increase its favorable publicity and goodwill by assisting charitable organizations, including the business's own charitable foundation.

A business can provide for the compensation of its executives and other employees while at the same time increasing the business's favorable publicity and goodwill by assisting charitable organizations, including the business's own charitable foundation.

A business can plan in advance for significant charitable deductions in future high-income years.

These and other aspects, features and advantages of the present invention can be more fully understood from the accompanying drawings and description of certain embodiments thereof.

### DESCRIPTION OF THE DRAWINGS

Non-limiting and non-exhaustive embodiments of the present invention are described with reference to the accompanying drawings. In the drawings, like reference numerals refer to like parts throughout the various figures unless otherwise specified.

FIG. 1 illustrates one example of a process for managing a Business Charitable Equity Options for high-income years; and

FIG. 2 illustrates one example of a logic flow for managing a Business Charitable Equity Options for high-income years.

### DETAILED DESCRIPTION OF CERTAIN EMBODIMENTS

The present invention is described more fully hereinafter with reference to specific illustrative embodiments. This invention may, however, be embodied in many different forms and should not be construed as limited to the embodiments set forth herein; rather, these embodiments are provided so that this disclosure will be thorough and complete, and will fully convey the scope of the invention to those skilled in the art. The methods may involve one or more entities (including a person, business, non-profit, computer device, or the like) performing some or all parts of an action, or set of actions. The entities may communicate in-person, over a network, including a computer network, or the like. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrases “in another embodiment” or “in an alternate embodiment” as used herein does not necessarily refer to a different embodiment, although it may. Thus, as described below, various embodiments of the invention may be readily combined, without departing from the scope or spirit of the invention.

In addition, as used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “decision maker” refers to a director, an officer, an employee, a committee, a partner, a general partner, a manager, a member, a trustee, trustee in bankruptcy, agent, attorney-in-fact, advisor, singly or in any combination, who or which is in a position to make decisions for or on behalf of a business or affecting a business.

The term “asset” means an item of property in which the business owns or holds an ownership interest or beneficial interest, directly or indirectly, and encompasses all forms and varieties of assets, including without limitation, partial interests, undivided interests, jointly held interests, co-tenancy interests, stock, equity interests, tangibles, real estate, personality, as well as intangibles of every variety and description, including without limitation goodwill, paper, interests in litigation, records, intellectual property, and investment interests.

The terms “stock” and “equity” refer to any type of equity ownership in a business, including preferred stock, common stock, LLC units, partnership units, or the like.

The term “strawman” refers to any surrogate, agent, or designee of an entity.

### Illustrative Business Charitable Equity Options for High-Income Years Embodiments

Charitable Equity Options rely on the general provisions relating to the charitable income tax deduction, Code Section 170. Charitable Equity Options are essentially in the nature of common law charitable pledges, which are not deductible by the business until the stock or other business equity interests are issued to the charity. The law permitting their use is to be found in a series of IRS rulings, including a Revenue Ruling, beginning in 1975 and from time to time (usually in the form of private letter rulings) since then.

Charitable Equity Options may be considered a form of “bargain sale” or “bargain purchase.” As used in the charitable giving arts and under the Code and Treasury Regulations, the term “bargain sale” includes a sale by a non-charity to a charity of an asset, at a purchase price less than the fair market value of the asset; in such a case, the seller is usually entitled to a charitable deduction for the difference between the asset's actual value and the amount the seller receives from the charity.

As used herein, the terms “option,” “option grant,” “pledge,” “option pledge,” “charitable option pledge,” and “charitable option grant,” refer to an agreement (which may be oral or in writing) or undertaking, or the like, by a business that, if certain conditions are met (including merely the passage of time), the holder of the “option” may “exercise” the option, either by providing to the business valuable consideration, including a sum of money, property, assets, or even a promissory note, or the like, or by a “cashless” exercise.

As used herein, the terms “issue”, “grant,” and “pledge” refers to an offer or expressed intention, whether written or not, under which a business or its surrogate/strawman is conveying a right or power to an option holder to receive equity interests at some future date if some specified condition or conditions are met.

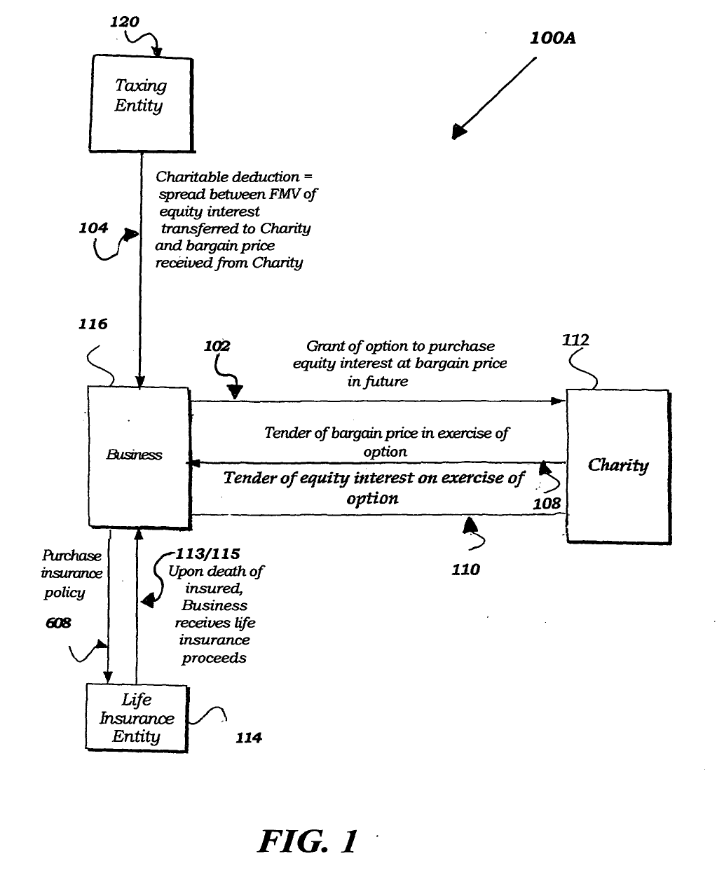

FIG. 1 illustrates one example of a process for managing a Business Charitable Equity Options for high-income years. The uses of Charitable Equity Options are potentially limitless to a business, such as Business 116. Uses include: pre-planning for a future high-income year; pre-planning for an IPO; pre-planning for a merger or acquisition; pre-planning for a reorganization; pre-planning for sale of an asset or division, etc.; pre-planning for a business expansion; pre-planning for future good publicity for charitable giving; ability to secure favorable recognition now about a gift not made until later, if at all; gives owners of privately held business the ability to “reach their control” forward to a time, after an IPO or acquisition, e.g., when they do not have such untrammeled power in the business as they do when utilizing the Charitable Equity Options tool.

Thus, in accordance with one embodiment of the invention, Business 116 can plan in advance for future high-income years, by issuing Charitable Equity Options to its selected charity, including Business 116's own charitable foundation (e.g., Charity 112). Business 116 issues an option grant to Charity 112, under which Charity 112 is entitled to receive an equity interest in Business 116 for a bargain-sale price in a future year. In the option grant document, Business 116 establishes the amount which the charity is to pay for the equity interest (the “strike price”), which is set well below the current and anticipated fair market value of the equity interest, so there is a difference (a “spread”) between the fair market value of the equity interest and the price the charity is to pay for the equity interest. The option grant document also specifies when the charity will be entitled to exercise the option (the “triggering event”), as for example, in a year when Business 116's income reaches a specified amount. When the triggering event occurs, the charity may tender the strike price to Business 116 (including in a “cashless” exercise), and Business 116 transfers the equity interest to the Charity 112. Business 116 is entitled to a charitable deduction in the year of Charity 112's exercise of the option, equal to the difference, or spread, between the price paid by Charity 112, and the then fair market value of the equity interest. Business 116 can use this charitable deduction to offset income in the high-income year.

If desired, Business 116 can “make up” or restore or compensate to itself the value of the equity interest received by Business 116's selected Charity 112. This “make up” or compensation is accomplished through one or more life insurance policies (or similar investments) on one or more corporate executives, employees, directors, or others with the insurance proceeds to be paid to Business 116 or its designee or surrogate/strawman. The premiums on this policy can be paid from the tax savings generated by the Business Charitable Equity Options.

As shown, at step 102, Business 116 issues equity option grant to Charity 112, entitling Charity 112 to purchase equity interest in Business 116 at bargain price in a future year in which Business 116 income reaches a specified amount. In another embodiment, Business 116 may grant Charitable Equity Options to more than one charitable organization, or Business 116 may designate one or more of a variety of different “triggering events,” such as the approval of a patent, the opening of a new office, the unveiling of a new retail line, or the like.

At step 108, upon Business 116 income reaching the specified amount, Charity 112 tenders the bargain purchase price to Business 116 and, at step 110, Business 116 transfers the equity interest to Charity 112. In one embodiment, step 110 may occur before step 108, after step 108, or concurrently.

At step 104, Business 116 is entitled to a charitable deduction for the difference between the bargain price paid by Charity 112, and the then-fair market value of the equity interest transferred to Charity 112.

At step 113/115, if Business 116 has insured lives of one or more executives, Business 116 receives life insurance proceeds on death of insured.

Components of system 100A may be an entity (person, business, or any other legal entity) or may, in some cases, be a computer device configured to perform at least some of the actions, on behalf of a person, business, or any other legal entity, as described herein. The computer device(s) may be configured with hardware and/or computer readable medium (e.g., software) for performing the actions. Components of system 100A may be in communication with each other over a variety of mechanisms, including, over a computer network, a wireless network, over a telephone network, in-person, or the like. Hence, the arrangement of system 100A can include any mechanism for communicating data over a network, including computers, mobile devices, embedded devices or the like. Any components used can provide user interfaces (including Hypertext Markup Language (HTML)/eXtensible Markup Language (XML)/Hypertext Transfer Protocol (HTTP) interfaces) to a user to control the device, or can operate automatically or semi-automatically under program control. The components of system 100A communicate with each other over a network, such as a Local Area Network (LAN), Wide Area Network(WAN), the Internet or the like. Alternatively, one or more components communicate with each other through a direct connection. In some embodiments, some components can be hosted on the same device and communicate through a data bus, memory, or the like.

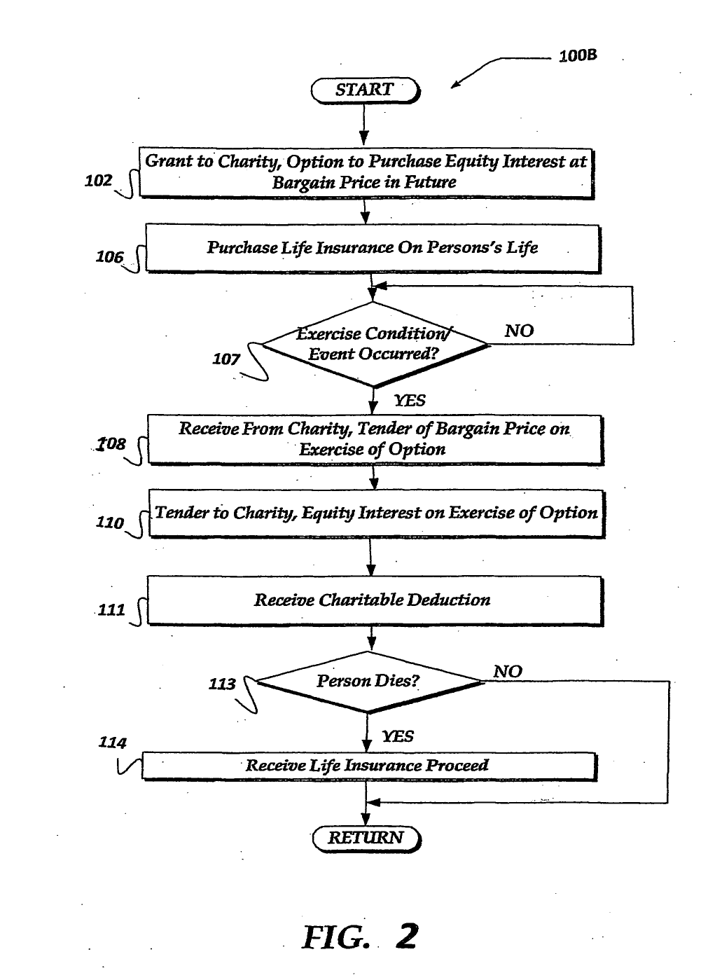

FIG. 2 illustrates one example of a logic flow for managing a Business Charitable Equity Options for high-income years. Process 100B of FIG. 2 begins at step 102 where Business 116 grants to Charity 112, an option to purchase an equity interest in Business 116 at bargain price in a future year when the option becomes exercisable. The option will become exercisable by Charity 112 if certain specified event(s) occur or if certain conditions are present or the like.

The option may be granted with a document, a series of documents, an email or letter exchange, phone call, or live meetings, or any mechanism of communication. The option need not satisfy any contract requirements, so long as the business actually does accept a sum (or other asset) from a charity (or alternatively, accepts a “cashless” exercise) and gives the charity equity units. The option grant document can (but need not) specify the terms or conditions as to when the option can be exercised.

The option may grant Charity 112 the express right to exercise. However, there need not be, but usually is, some sort of enforceable power or right in Charity 112. For example, the grant can provide that Business 116 has no obligation at all to the Charity 112, and if Business 116 grants the equity interests, Business 116 does so without legal compulsion.

In an alternate embodiment, at step 102, a third-party may issue the option grant to Charity 112 on behalf of Business 116. Possible issuers include: a subsidiary of the business, an executive at the business; an executive at an affiliated business; a retiree; a past or present board member; more than one such executive, retiree, or board member; an affiliated firm; an agent for the business, such as a bank, investment banker, broker, attorney, accountant, etc.; any other surrogate, strawman, or alter ego of the business.

In an alternate embodiment, at step 102, the option may be granted to a number of different charities, a group of charities, a trust of whom charities are the beneficiary, any type of surrogates, straw men, or alter egos for one or more charities, or the like.

Processing next continues to block 106, where Business 116, or its surrogate/strawman or designee, buys an insurance policy for a life of at least one person (e.g. an executive of Business 116) for whom the Business 116 has an insurable interest, from Insurance Entity 114. At step 106, a premium may also be paid for the life insurance policy.

Processing next continues to decision step 107, where it is determined whether the exercise condition/event provided in the option has occurred or exists. The condition/event may be any determinable state, including whether Business 116 has income of more than an amount for number of years in a row, whether Business 116 has a patent approved, whether three years from the date of issuance of this grant has occurred, or the like. If it is determined that the exercise condition/event has occurred, processing continues to step 108. Otherwise, processing loops back to decision step 107 for further processing.

Processing next continues to block 108, where Charity 112 tenders to Business 116 the bargain price—e.g., a specified price (usually called a “strike price” in other option realms, such as employee stock options, e.g.).

Processing next continues to block 108, where Business 116 provides Charity 112 equity interests in Business 116 (i.e., stock if the issuing business is a corporation, units if the business is an LLC, etc). While preferably, it is the Business 116 itself which transfers the equity units to Charity 112, any direct or indirect agent, surrogate, strawman, or other representative of the business can make the transfer. Also, while the equity units are standard units of equity or ownership in the business (i.e., common stock in a corporation, membership units in an LLC), the equity units can be different than “standard” units, including a virtually limitless array of possible interests, including without limitation, preferred stock, “type A” units, restricted stock, special “charitable ownership interest” units, or the like.

Processing next continues to block 111, where Business 116 receives a charitable deduction (including tax deduction, credit or exemption) for tendering the equity to Charity 112. Business 116 receives the charitable deduction in the taxable year in which the equity interests are issued to the charity, equal to the difference, or “spread” between the strike price and the fair market value of the equity interests issued to the charity. The charitable deduction can be provided under federal, state or local law, as opposed to a federal income tax deduction.

At step 113, it is determined whether a person whose life is insured under the life insurance policy has died. If the person has died, then processing continues to step 114. Otherwise, processing continues to other steps.

At step 114, if Business 116 has insured lives of one or more persons, directors, and/or employees by buying an insurance policy from Insurance Entity 114, Business 116 (or any other party designated by Business 116) receives life insurance proceeds on the death of the insured (e.g. immediately, or spread over a term of years, or the like). Processing then continues to other steps.

At least in some embodiments, managing the insurance polices may be optional. Thus, in these embodiments, steps 106, 113 and 114, may not be performed.

The reader will appreciate that the Charity Equity Options for High Income Years (“CheEO”) provides particular qualities and advantages, including: the ChEOs uniquely afford the business the ability to pre-plan for future events with virtually limitless flexibility and precision; ChEOs afford the business the ability to pre-plan for the creation of charitable deductions in future years by planning now; ChEOs permit the business to choose the precise combination of strike price, vesting triggering event(s), and exercise format which most completely and advantageously meet its planning goals; the business can select the one or more charities as optionholders which it most desires to benefit, including its own charitable foundation; ChEOs require no outlay of cash or assets by the business to create; if and when ChEOs are exercised, the business's outlay is limited to equity units, including shares of stock in the case of a corporation, and involves no other outlay of cash or assets; and/or ChEOs afford the business the opportunity of favorable publicity and community goodwill both at the granting of the option and at the time of exercise of the option (and, if the optionholder is the business's own charitable foundation, at each time the foundation makes a grant to a public charity).

Accordingly, the reader will see that at least some embodiments of the invention provides the mechanism for the preplanning to lower Business 116's income tax liability in a future high-income year, and also the mechanism for Business 116 to provide funding to Charity 112, thus enhancing its community goodwill and favorable publicity, as well as the means to make up for the value of the equity interest transferred to Charity 112 via life insurance.

It will be understood that the steps of the flowchart illustrations described herein can be performed in different orders and some steps may be omitted, without departing from the spirit of the invention.

It will also be understood that certain steps in the flowchart illustrations, and combinations of steps in the flowchart illustrations, can be implemented by computer program instructions. These program instructions can be provided to a processor to produce a machine, such that the instructions, which execute on the processor, create means for implementing the actions specified in the flowchart step or steps. The computer program instructions can be executed by a processor to cause a series of operational steps to be performed by the processor to produce a computer implemented process such that the instructions, which execute on the processor to provide steps for implementing the actions specified in the flowchart step or steps. The computer program instructions can also cause at least some of the operational steps shown in the steps of the flowchart to be performed in parallel. Moreover, some of the steps may also be performed across more than one processor, such as might arise in a multi-processor computer system.

Accordingly, steps of the flowchart illustrations support combinations of means for performing the specified actions, combinations of steps for performing the specified actions and program instruction means for performing the specified actions. It will also be understood that each step of the flowchart illustrations, and combinations of steps in the flowchart illustrations, can be implemented by special purpose hardware-based systems which perform the specified actions or steps, or combinations of special purpose hardware and computer instructions. Further, it should be understood that aspects of any particular embodiment can be combined with features and aspects of other embodiments in practicing the present invention.

Since many embodiments of the invention can be made without departing from the spirit and scope of the invention, the invention is to be defined by the claims hereinafter appended.

What is claimed is:

1. A method in support of charitable giving by a business, comprising:
(a) granting, by the business to a charity, an option to purchase an equity interest in the business at a bargain price;
(b) if an exercise condition or an event of the option occurs:
(i) the business tendering to the charity the equity interest; and
(ii) the business receiving from the charity the bargain price; and
(c) the business receiving an income tax deduction for tendering the equity interest upon the charity's exercise of the option.
